(19) United States
(12) Patent Application Publication
(10) Pub. No.: US 2022/0252185 A1
(43) Pub. Date: Aug. 11, 2022

(54) SUBSEA CABLE INSTALLATION AND RECOVERY SYSTEM

(71) Applicant: Deep Down, Inc., Houston, TX (US)

(72) Inventors: Michael Fields, Houston, TX (US); Jacob Hardgrave, Houston, TX (US); Troy Moran, Houston, TX (US); Ronald E. Smith, Houston, TX (US); Neil Stuckey, Houston, TX (US); Dustin Goitia, Houston, TX (US); Christopher Sebesta, Houston, TX (US)

(73) Assignee: Deep Down, Inc., Houston, TX (US)

(21) Appl. No.: 17/170,124

(22) Filed: Feb. 8, 2021

(51) Int. Cl. F16L 1/20

(52) U.S. Cl. CPC F16L 1/207

(57) ABSTRACT

A subsea cable installation and recovery system to provide cables to various subsea tools. The subsea cable installation and recovery system may include a subsea cable transportation unit. The subsea cable transportation unit may include a base platform and a drive unit provided within the base platform. Additionally, a storage structure may be provided on the base platform and operationally coupled to the drive unit. The storage structure may be configured to receive a drum. At least one drive connection may be provided on a surface of the base platform. The at least one drive connection may be operationally coupled to the drive unit and configured to provide torque or hydraulics to operate the drive unit. The storage structure may be configured to rotate based on the torque or hydraulics and unspool or spool a cable wrapped around the drum. A stabilizing fin may extend outwardly from the base platform.

### BACKGROUND

Subsea cables are used in the oil and gas industry and the renewable energy industry to connect a host to a subsea production facility. Cables may include umbilicals that are multi-part cables. The Subsea cables may be a bundle of cables and conduits that transfer hydraulic and/or electric power within the field (long distances), or from topsides to subsea. Additionally, subsea cables may also carry fluids. The host may be a floating production storage and offloading vessel (FPSO), a floating rig, or any offshore-based facility. The host is manned, and the subsea production facility is unmanned. The subsea umbilical may include a) tubing for various fluids including hydraulic fluid, chemicals such as methanol, and/or injection/production fluids; b) electrical power cables; c) fiber optic cables; d) wire rope; e) fillers; f) reinforcements and/or combinations thereof.

Some of the subsea oil production facilities are in thousands of feet of water and therefore the conventional subsea cables may be several thousand feet long. When using umbilicals, the umbilical hangs off an I-tube or a J-tube on the host and connects to the topside umbilical termination assembly (TUTA). Subsea, the umbilical often connects to an umbilical termination assembly, referred to in the industry as a UTA. As the subsea cables are conveyed in deep waters, higher installation tensions may cause a need to have increased cable strengths to handle loads.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a subsea cable transportation unit. The subsea cable transportation unit may include a base platform; a drive unit may be provided within the base platform; a storage structure may be provided on the base platform and operationally coupled to the drive unit, wherein the storage structure may be configured to receive a drum; at least one drive connection may be provided on a surface of the base platform, wherein the at least one drive connection may be operationally coupled to the drive unit and configured to provide torque or hydraulics to operate the drive unit, wherein the storage structure may be configured to rotate based on the torque or hydraulics and unspool or spool a cable wrapped around the drum; and a stabilizing fin may extend outwardly from the base platform, the stabilizing fin may include a hydrofoil. The drive unit may include a shaft having a first end attached to the at least one drive connection; a motor attached to a second end of the shaft; and a gear operationally coupled to the motor. A peripheral edge of the storage structure may include teeth and the teeth may be engaged with corresponding teeth of the gear. A level winder may be movably coupled to a rod on the base platform, wherein the level winder may be configured to move up and down the rod based on a height of the cable wrapped around the drum. A center post may extend outwardly from the base platform, the center post may include a lift connection.

In another aspect, embodiments disclosed herein relate to a subsea cable installation and recovery system. The subsea cable installation and recovery system may include a subsea cable transportation unit. The subsea cable transportation unit may include a base platform, wherein a drive unit may be provided within the base platform; a storage structure may be provided on the base platform and operationally coupled to the drive unit; a stabilizing fin may extend outwardly from the base platform, wherein the stabilizing fin may include a hydrofoil configured to displace fluids and stabilize the subsea cable transportation unit submerged in the body of water. A cable reel may be installed on the storage structure, wherein the drive unit may be configured to rotate the storage structure to turn the cable reel, wherein the cable reel may include a spool of cable wrapped around a drum. The subsea cable installation and recovery system may further include an offshore vessel at a surface of a body of water, the offshore vessel may include a crane and a line coupled to the crane, the line may be removably attached to the subsea umbilical transportation unit. The storage structure may include a locking device to lock the drum on the storage structure. A remotely-operated-vehicle (ROV) may be operationally coupled to the subsea cable transportation unit. The ROV may be removably coupled to at least one drive connection of the subsea cable transportation unit and may be configured to transmit torque or hydraulics to the drive unit through the at least one drive connection. The ROV may include thrusters to move the subsea cable transportation unit within the body of water. A level winder may be movably coupled to a rod or hydraulic cylinder on the base platform, wherein the level winder may be configured to move up and down the rod or up and down based in response to the hydraulic cylinder based on a height of the spool of cable wrapped around the drum. Further, the ROV may be operationally coupled to a hot stab of the level winder to move the level winder up and down as the height of the spool of cable changes from unspooling or spooling.

In yet another aspect, embodiments disclosed herein relate to a method. The method may include deploying a subsea cable transportation unit in a body of water at an offshore site; directing the subsea cable transportation unit through the body of water; and torqueing a drive unit provided within a base platform of the subsea cable transportation unit to drive a storage structure installed on the base platform; rotating the rotatable table with power from the drive unit, thereby unspooling or spooling a spool of cable installed on the storage structure; and stabilizing the subsea cable transportation unit in the body of water with a stabilizing fin positioned outwardly from the base platform. The deploying of the subsea cable transportation unit may include: lifting the subsea cable transportation unit off an offshore vessel with a crane attached to a post extending outwardly from the base platform; lowering the subsea cable transportation unit into the body of water with the crane; and submersing the subsea cable transportation unit in the body of water and moving the subsea cable transportation unit to a subsea site. The method may further include maintaining the subsea cable transportation unit at a distance of 20 to 50 feet above a sea floor and lowering the subsea cable transportation unit to the sea floor. The torqueing the drive unit may include operationally coupling a remotely-operated-vehicle (ROV) to a torque connection of the subsea cable transportation unit and providing a drive torque to the drive unit. The method may further include operationally coupling the ROV to a hot stab of a level winder movably coupled to the base platform, and mechanically or hydraulically moving the level winder up and down based on a height of the spool of cable, and sliding the spool of cable down a chute or ramp of the level winder.

Other aspects and advantages will be apparent from the following description and the appended claims.

### BRIEF DESCRIPTION OF DRAWINGS

FIG. 1 is a perspective view of a subsea cable transportation unit in accordance with embodiments disclosed herein.

FIGS. 2A and 2B are close perspective top views of the subsea cable transportation unit of FIG. 1 in accordance with embodiments disclosed herein.

FIGS. 3A and 3B are front views of a subsea cable transportation unit of FIG. 1 in accordance with embodiments disclosed herein.

FIG. 4 is a schematic of an offshore system in accordance with embodiments disclosed herein.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

As used herein, the term “coupled” or “coupled to” or “connected” or “connected to” “attached” or “attached to” may indicate establishing either a direct or indirect connection, and is not limited to either unless expressly referenced as such. Wherever possible, like or identical reference numerals are used in the figures to identify common or the same elements. The figures are not necessarily to scale and certain features and certain views of the figures may be shown exaggerated in scale for purposes of clarification. In addition, any terms designating a subsea cable installation and recovery system at an offshore vessel (i.e., any offshore rig or platform, wind or wave farms) should not be deemed to limit the scope of the disclosure. It is to be further understood that the various embodiments described herein may be used in various stages of a well or an offshore wind or an offshore wave farm, such as site preparation, drilling, completion, abandonment etc., and in other environments, such as work-over rigs, fracking installation, well-testing installation, oil and gas production installation, without departing from the scope of the present disclosure. It is recognized by the different embodiments described herein that a subsea umbilical transportation unit may play a valuable and useful role in the life of a well. Further, it is recognized that the subsea cable installation and recovery system configuration and arrangement of components for holding, storing, transporting, spooling and/or unspooling rigid and flexible pipe products, including various types of cables in a subsea environment according to one or more embodiments described herein may provide a cost effective alternative to conventional systems and eliminate tension in the cables. The embodiments are described merely as examples of useful applications, which are not limited to any specific details of the embodiments herein.

Embodiments disclosed herein relate generally to offshore industries, including, for example, subsea oil and gas operations equipment, offshore wind and wave farm equipment, or any other offshore equipment uses in any industry. More specifically, embodiments disclosed herein relate to systems and methods of use for a subsea cable installation and recovery system to provide cables to various subsea tools. In one aspect, embodiments disclosed herein relate to the subsea cable installation and recovery system including a subsea cable transportation unit having a base platform with a drive unit used for rotating a storage structure on the base platform. The subsea cable transportation unit may be used to unspool or spool cable(s) installed on the storage structure. In a non-limiting example, a stabilizing fin may extend from the base platform to displace fluids and stabilize the subsea cable transportation unit as the subsea cable transportation unit is submerged in a body of water. While the terms forward and rear are used herein, one of ordinary skill in the art will appreciate that in some embodiments a subsea cable transportation unit may move in other or opposite directions and therefore those elements labeled forward may be rear and those labeled rear may be forward.

According to embodiments of the present disclosure, cables may be rigid and/or flexible pipe products that are manufactured and/or assembled in long segments onshore for use in offshore applications. In a non-limiting example, these cables may be umbilicals, a hardline, cable, multiplexed (MUX) cable, or fluid conduits that can transmit power, fluids, or communications or any combination thereof between devices. For example, the form of communication may include, but not limited to, pressure pulses (air or liquid), electrical signals for communication over power lines, copper wires, fiber optics, or any combination thereof. In some embodiments, these cables are wound around a drum to form a spool of cable(s) for storage and transportation to an offshore vessel. In subsea environments, cables, such as fiber optic or sensor cables, may not be able to support a weight of a water column. Additionally, the cables may have a limited allowable tension from pulling forces. Embodiments of the present disclosure provide a system that may allow for reduction or elimination of tension in the cables at various depths in subsea environments. Once the subsea cable transportation unit is positioned in the subsea environments in accordance with embodiments disclosed herein, the spool of cable(s) may be unspooled or spooled without putting tension on the cables. In some embodiments, the subsea cable transportation unit may be used to unload and install a cable reel on a sea floor. The cable reel may be a bundle of the cables around a drum.

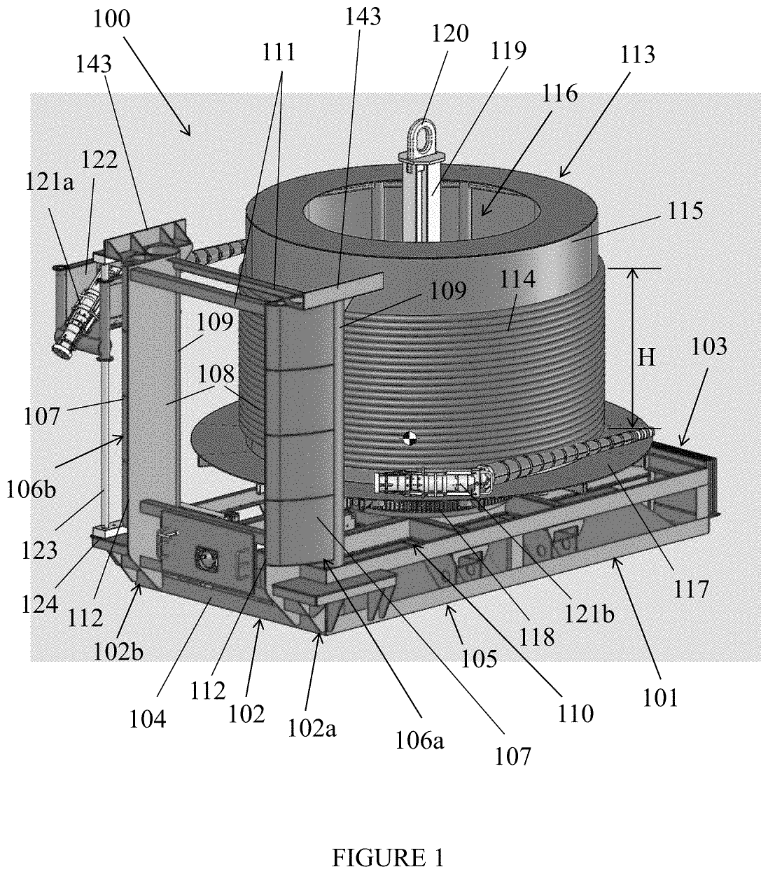

FIG. 1 shows a subsea cable transportation unit 100 in accordance with the present disclosure. The subsea cable transportation unit 100 may have a base platform 101 extending in a horizontal direction from a first end surface 102 to a second end surface 103. The first end surface 102 may be a front end of the subsea cable transportation unit 100. Additionally, the first end surface 102 may have an angled portion 104. In a non-limiting example, when the subsea cable transportation unit 100 is traveling in a body of water, the angled portion 104 may direct fluids of the body of water underneath a bottom surface 105 of the base platform 101. As shown, the angled portion 104 may be angled outwardly upward as it extends upward from the bottom surface 105 of the base platform 101. The angled portion 104 may aid in smoother travel of the subsea cable transportation unit 100 in the body of water as the angled portion 104 displaces fluid away from the subsea cable transportation unit 100. The second end surface 103 may be a back end of the of the subsea cable transportation unit 100 and may be perpendicular the bottom surface 105. In some embodiments, the second end surface 103 may also include an angled portion that angles outwardly upward from the bottom surface 105 similar to angled portion 104. While it is noted that the base plate 101 is shown to be rectangular, one skilled in the art will appreciate that the base plate 101 may be circular, square, triangular, etc., without departing from the scope of present disclosure.

In one or more embodiments, one or more stabilizing fins 106a, 106b may extend outwardly from the base platform 101. In a non-limiting example, a first stabilizing fin 106a may be spaced a distance apart from a second stabilizing fin 106b. Additionally, both the first stabilizing fin 106a and the second stabilizing fin 106b may be positioned at the front end of the of the subsea cable transportation unit 100. In a non-limiting example, the first stabilizing fin 106a may be placed at a first corner 102a at the front end of the base platform 101. Additionally, the second stabilizing fin 106b may be placed at a second corner 102b at the front end of the base platform 101. It is further envisioned that the two stabilizing fins 106a, 106b may be placed in corners at the rear end of the base platform 101. While it is noted that only two stabilizing fins (106a, 106b) are shown, this is for example purposes only and any number of stabilizing fins may be used without departing from the present scope of the disclosure. For example, in some embodiments, two, three, or more stabilizing fins may be located on the base platform 101 and spaced apart around the perimeter of the base platform 101. Each stabilizing fin 106a, 106b may extend vertically upward from the base platform 101 and may include a shape, as discussed further below, that helps provide stability to the subsea cable transportation unit 100 as it is lowered, moved, or suspended in water. It is further envisioned that one or more support rods 111 may extend between stabilizing fins 106a, 106b, for example, from the first stabilizing fin 106a to the second stabilizing fin 106b. The one or more support rods 111 may be attached to ends of the first stabilizing fin 106a and the second stabilizing fin 106b distal from the base platform 101. The one or more support rods 111 may aid in reducing movement of the first stabilizing fin 106a and the second stabilizing fin 106b caused by the body of water. In addition, one or more brackets 143 may be provided at the ends of the first stabilizing fin 106a and/or the second stabilizing fin 106b distal from the base platform 101. The one or more brackets 143 may provide additional structural integrity to the first stabilizing fin 106a and/or the second stabilizing fin 106b from induced stresses from the body of water and operating the subsea cable transportation unit 100.

One or more stabilizing fins 106a, 106b may be a hydrofoil to displace fluids and stabilize the subsea cable transportation unit 100 submerged in the body of water. As a hydrofoil, the stabilizing fins 106a, 106b may minimize water drag on the subsea cable transportation unit 100. Additionally, the stabilizing fins 106a, 106b may aid in stabilizing, such as leveling the subsea cable transportation unit 100 or keeping the subsea cable transportation unit 100 in a straight line while moving through the body of water. In a non-limiting example, each stabilizing fin 106a, 106b may be a blade having a first surface 107 and a second surface 108. The blade may be attached to a pole 109 extending from a top surface 110 of the base platform 101. The second surface 108 may be flat and extend to the top surface 110 or the bottom surface 105 of the base platform 101. Further, the first surface 107 may have a transversely curved profile. As shown, the stabilizing fins 106a,106b are positioned such that the first surface 107 having a transversely curved profile faces away from an interior of the base platform 101. In other words, the first surface 107 having a transversely curved profile faces exteriorly. In a non-limiting example, a radius of the curved profile may gradually increase from a minimum at forward most edge 112 (in a direction of travel) to a maximum at a rearward most edge of the curved provide proximate the pole 109. The forward most edge 112 may be a position at which the first surface 107 and the second surface 108 meet distal to the pole 109. As shown in FIG. 1, the forward most edge 112 may extend in a vertical direction and be positioned at a greater distance from a center of the base platform 101 than the rearward most edge.

Still referring to FIG. 1, in one or more embodiments, a cable reel 113 may be installed on the top surface 110 of the base platform 101. The cable reel 113 may be a cable 114, such as an umbilical, a fiber optic cable, a sensor cable, or any other type of subsea cables wound around a drum 115 to form a spool of cable. As shown in FIG. 1, the drum 115 is a cylindrical body with a hollow center 116 extending from a base plate 117. Additionally, the base plate 117 may be installed on a storage structure 118 of the base platform 101. The storage structure 118 may be a circular rotatable table. While it is noted that the storage structure 118 is shown to be circular, one skilled in the art will appreciate that the base plate 101 may be rectangular, square, triangular, etc., without departing from the scope of present disclosure. Further, a center post 119 extending outwardly from the base platform 101 through the hollow center 116 of the drum 115. In a non-limiting example, the center post 119 may extend outwardly from the base platform 101 in a vertical direction to be an upright post. The drum 115 may be coaxial with the center post 119 such that the drum 115 may have a vertical orientation. In other embodiments, the drum 115 may be oriented horizontally. Furthermore, the center post 119 may have a lift connection 120 to allow a crane to lift the subsea cable transportation unit 100. In other embodiments, the lift connection 120 may be provided on any surface of the subsea cable transportation unit 100 such as the base platform 101 and/or the stabilizing fins 106a, 106b.

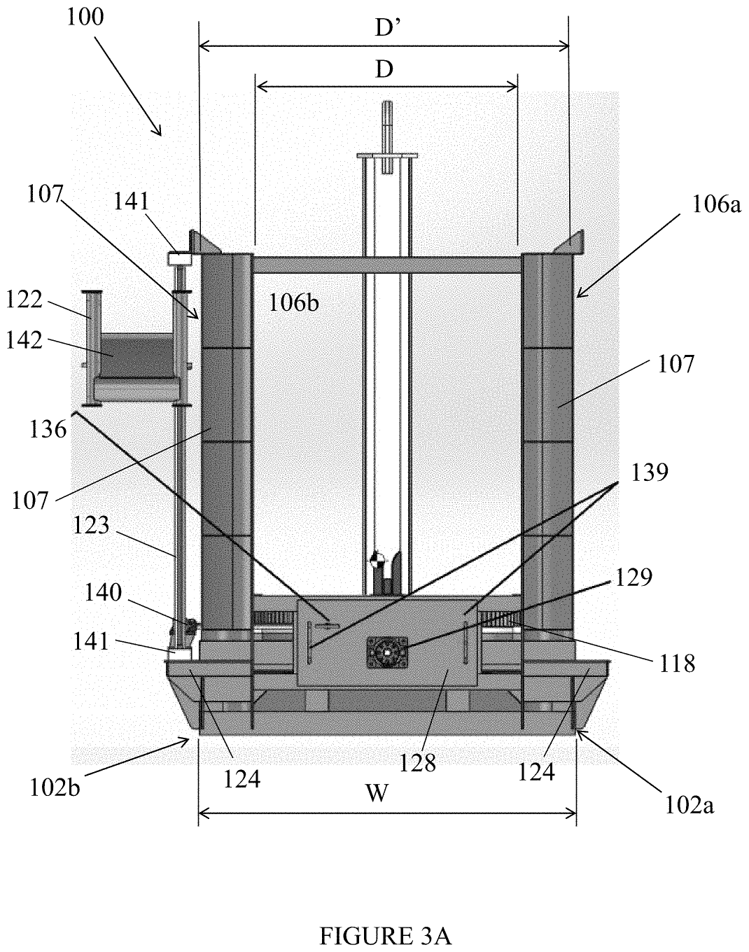

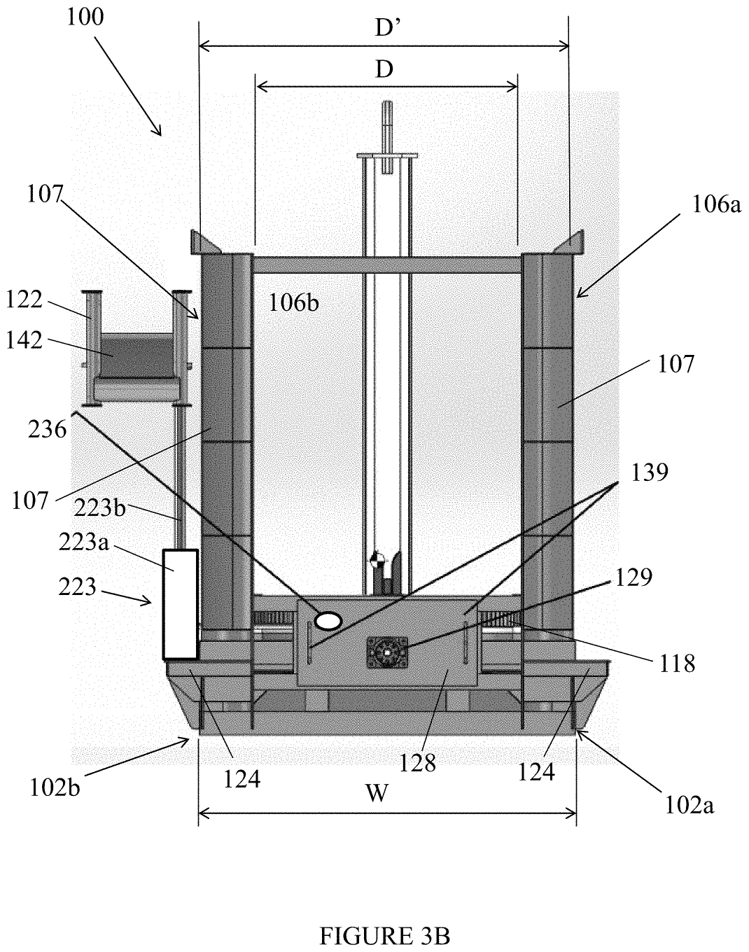

As shown in FIG. 1, in one or more embodiments, the subsea cable transportation unit 100 may also include a level winder 122 to assist in spooling and unspooling the cable 114 from the drum 115 and reducing tension on the umbilical. In some embodiments, the cable 114 may have a first connection end 121a and a second connection end 121b. In a non-limiting example, the first connection end 121a may be installed on the level winder 122. The level winder 122 may be movably coupled to a rod 123 or a hydraulic cylinder (see 223 in FIG. 3B) coupled to the base platform 101. In one embodiment, the rod 123 or the hydraulic cylinder (see 223 in FIG. 3B) may be installed on a step 124 of the base platform 101. The step 124 may be provided on both corners 102a, 102b of the front end of the base platform 101 to allow for the rod 123 and the level winder 122 to be on either side of the base platform 101. Additionally, the level winder 122 may have a vertical position on the rod 123 based on a height H of the cable 114 wrapped on the drum 115 from the base plate 117. In a non-limiting example, as the storage structure 118 rotates, the cable reel(s) 113 may rotate to unspool or spool the cable 114 on the drum 115. Subsequently, the height of the cable 114 wrapped on the drum 115 changes based on the unspooling or spooling of the cable 114. As the height of the cable 114 wrapped on the drum 115 changes, the level winder 122 moves either up or down on the rod 123 (or in response to the hydraulic cylinder 223 in FIG. 3B) to ensure that the first connection end 121a is level to the height H of the spooled cable 114. An ROV may be used to actuate and/or power the level winder as described further below. It is further envisioned that the first connection end 121a may be connected to a subsea device while the second connection end 121b may be connected to an offshore vessel or other subsea devices.

In one or more embodiments, the subsea cable transportation unit 100 may be used to unload and dispose the cable reel 113 on a sea floor. In a non-limiting example, the base platform 101 may include hydraulics to lift the cable reel 113 off the subsea cable transportation unit 100 and dispose the cable reel 113 on the sea floor. Additionally, a crane of an offshore vessel may be used to lift the cable reel 113 off the subsea cable transportation unit 100 and dispose the cable reel 113 on the sea floor. Further, an ROV may assist the subsea cable transportation unit 100 and the crane to lift the cable reel 113 off the subsea cable transportation unit 100 and dispose the cable reel 113 on the sea floor.

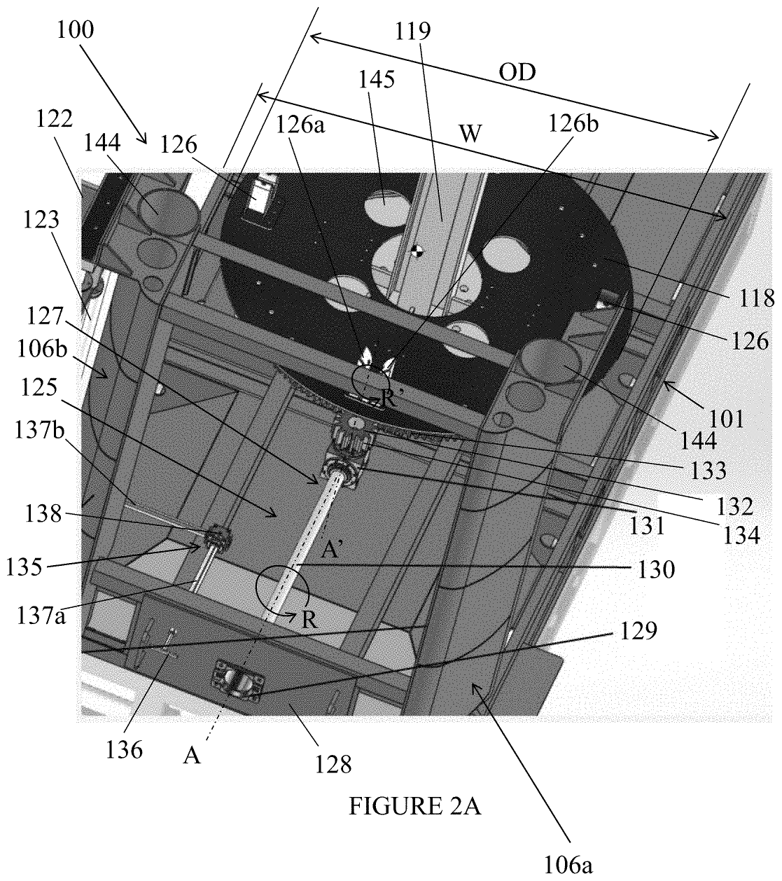

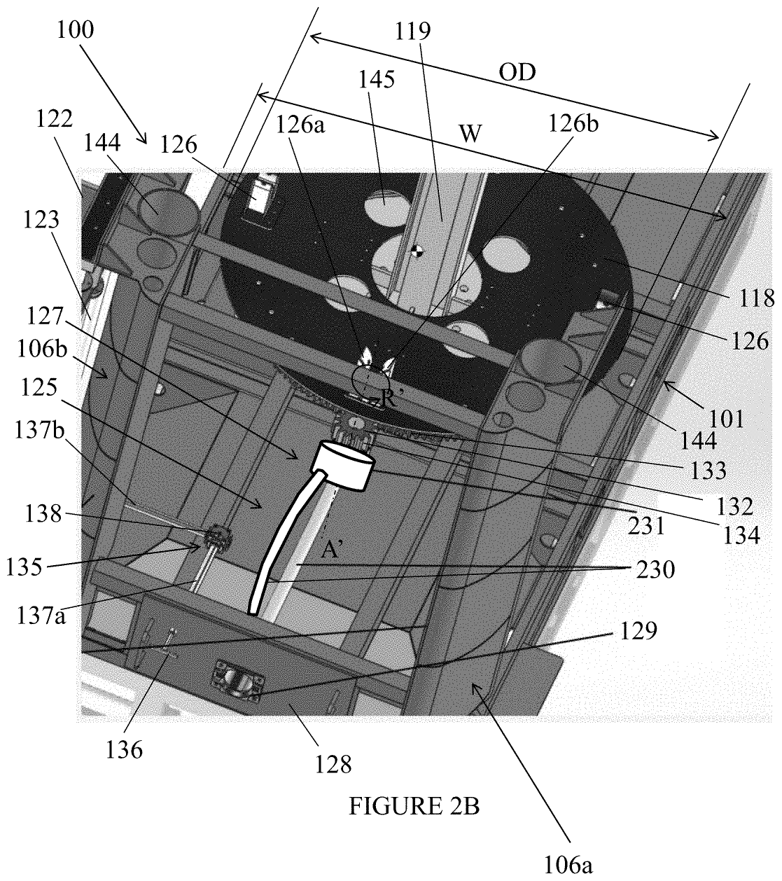

Referring now to FIGS. 2A and 2B, in one or more embodiments, a close-up perspective top view of the subsea cable transportation unit 100 without the cable reel (113 in FIG. 1) is shown. As shown in FIGS. 2A and 2B, the storage structure 118 may be provided with one or more locking devices 126. The locking devices 126 may be used to lock and align the base plate 117 of the cable reel 113. In a non-limiting example, the locking devices 126 may have two protrusions 126a, 126b for the base plate 117 to snap into. While it is noted that a profile of the storage structure 118 is shown to be circular, one skilled in the art will appreciate how the profile of the storage structure 118 may be any shape without departing from the present scope of the disclosure. It is further envisioned that a width W of the base platform 101 may be greater than or less than an outer diameter OD of the storage structure 118.

In one or more embodiments, each of the stabilizing fin 106a,106b may have one or more holes 144 at the ends of the first stabilizing fin 106a and the second stabilizing fin 106b distal from the base platform 101. The one or more holes 144 may extend downwardly into each of the stabilizing fin 106a,106b to make the each of the stabilizing fin 106a,106b partially hollow. The one or more holes 144 may allow for water to pass through so as not to trap any air within each of the stabilizing fin 106a,106b. Additionally, the storage structure 118 may include one or more through-holes 145. The one or more through-holes 145 may allow for water to flow between the storage structure 118 and the drum (115 in FIG. 1) to eliminate any air that may be between the storage structure 118 and the drum.

In some embodiments, a drive unit 127 of the subsea cable transportation unit 100 may be installed in a housing 125 formed behind a front plate 128 of the base platform 101. The housing 125 may be interchangeably referred to as a torque bucket or hydraulic bucket. The drive unit 127 may be torque or hydraulically driven. Additionally, the front plate 128 may include an opening at which a drive connection 129 of the drive unit 127 is provided within. The drive connection 129 may be a torque or hydraulic connection. In a non-limiting example, a torque or hydraulic tool (not shown) may plug into the drive connection 129 to provide torque or hydraulic power to the drive unit 127. In a non-limiting example, the torque or hydraulic tool, such as a flying lead orientation tool (“FLOT”), may be provided by a remotely-operated-vehicle (ROV) operationally coupled to the subsea cable transportation unit 100. As shown in FIG. 2A, the drive unit 127 may include the drive connection 129, a shaft 130, a motor 131, and a gear 132. The shaft 130 may extend from the drive connection 129 to the motor 131. Specifically, the motor 131 may be attached to an end of the shaft 130 opposite the drive connection 129. In the case that the drive unit 127 is torque driven, the torque tool plugs into the drive connection 129 to provide torque. Once torque is delivered to the shaft 130 (by way of the ROV via the torque tool), the shaft 130 may rotate R about an axis A to drive the motor 131. The motor 131 may then move the gear 132 by rotating R′ the gear 132 about an axis A′ perpendicular to the axis A. As the gear 132 rotates, teeth 133 at a peripheral edge of the rotatable table 118 engage with corresponding teeth 134 of the gear 132 to rotate the rotatable table 118 around the center post 119.

In the case that the drive unit 127 is hydraulically driven, the hydraulic tool plugs into the drive connection 129 to provide hydraulics. As shown by FIG. 2B, the shaft (see 130 in FIG. 2A) may be replaced with hydraulics hoses 230 while the motor (see 131 in FIG. 2A) may be replaced with a hydraulic motor 231. The hydraulic motor 231 may be a mechanical actuator that converts hydraulic pressure and flow from the hydraulics hoses 230 into torque and angular displacement (rotation). Once hydraulics are delivered to the hydraulics hoses (by way of the ROV via the hydraulic tool), the hydraulics hoses 230 deliver the hydraulic pressure and flow to the hydraulic motor 231. As the hydraulic motor 231 converts hydraulic pressure and flow from the hydraulics hoses 230 into torque and angular displacement (rotation), the hydraulic motor 231 rotates the gear 132. As the gear 132 rotates, teeth 133 at a peripheral edge of the rotatable table 118 engage with corresponding teeth 134 of the gear 132 to rotate the rotatable table 118 around the center post 119.

Still referring to FIGS. 2A and 2B, in one or more embodiments, a hot stab 135 of the level winder 122 may have a handle 136 extending from the front plate 128. The ROV may engage the handle 136 to hydraulically or manually, operate the hot stab 135 and to move the level winder 122 up and down the rod 123. The ROV may have manipulators to manually operate the handle 136 to move the level winder 122. In one or more embodiments, the handle 136 may be a hydraulic port (see 236 in FIG. 3B) for the ROV to plug into and hydraulically move the level winder 122. In a non-limiting example, the hot stab 135 may have two rotating rods (137a, 137b) extending from a level winder motor 138. A first rotating rod 137a may extend from the handle 136 to the level winder motor 138 such that when the handle 136 rotates, the first rotating rod 137a rotates to provide torque to level winder motor 138. Once the level winder motor 138 receives torque from the first rotating rod 137a, the level winder motor 138 may use the received torque to rotate a second rotating rod 137b perpendicular to the first rotating rod 137a. The second rotating rod 137b may extend from the level winder motor 138 to a second level winder motor (140 in FIGS. 3A and 3B). The rotation of the second rotating rod 137b may provide torque to the second level winder motor (140 in FIGS. 3A and 3B) such that the second level winder motor drives the level winder 122 to move up and down the rod 123.

Now referring to FIGS. 3A and 3B, in one or more embodiments, a front view of the subsea cable transportation unit 100 without the cable reel (113 in FIG. 1) is shown. The front plate 128 may have a plurality of handles 139 for the ROV to grab and align with the drive connection 129. Additionally, the handle 136 may be positioned on the front plate 128 between the plurality of handles 139. As shown by FIG. 3A, a second level winder motor 140 may be provided on the step 124 to receive torque from the second rotating rod (137b in FIG. 2) to drive the level winder 122 up and down the rod 123. It is further envisioned that caps 141 may be provided at ends of the rod 123 to delimit a vertical movement of the level winder 122. In some embodiments, the level winder 122 may include a chute or ramp 142 that is angled downward to allow for the first connection end (121a in FIG. 1) of the cable (114 in FIG. 1) to rest on. The chute or ramp 142 may provide a transition from a horizontal to vertical orientation of the cable that prevents the cable from exceeding a minimum bend radius of the cable. As shown by FIG. 3B, the rod (see 123 in FIG. 3A) may be replaced with a hydraulic cylinder 223 installed on the step 124. In a non-limiting example, the hydraulic cylinder 223 may have a housing 223a with a piston 223b extending in and out of the housing 223a. Additionally, the level winder 122 may be operationally coupled to the piston 223b. In a non-limiting example, when the hydraulic cylinder 223 receives hydraulic pressure and fluids from the ROV, via a hydraulic port 236, the piston 223b may actuate to move the level winder 122 up or down.

In some embodiments, a step 124 may be positioned on one or more corners of the base platform 101 such that the steps 124 extend past the width W of the base platform 101. The step 124 may be provided at both the first corner 102a and the second corner 102b at the front end of the base platform 101. By extending past the width W of the base platform 101, the level winder 122 may be adjacent to either stabilizing fins 106a, 106b. Additionally, the first stabilizing fin 106a and the second stabilizing fin 106b may be spaced a distance D apart from each other. In a non-limiting example, the distance D may have a value equal to or greater than the outer diameter OD of the storage structure 118. Further, a distance D′ from an outer most point of the first surface 107 of the first stabilizing fins 106a to an outer most point of the first surface 107 of the second stabilizing fins 106b is equal to the width W of the base platform 101.

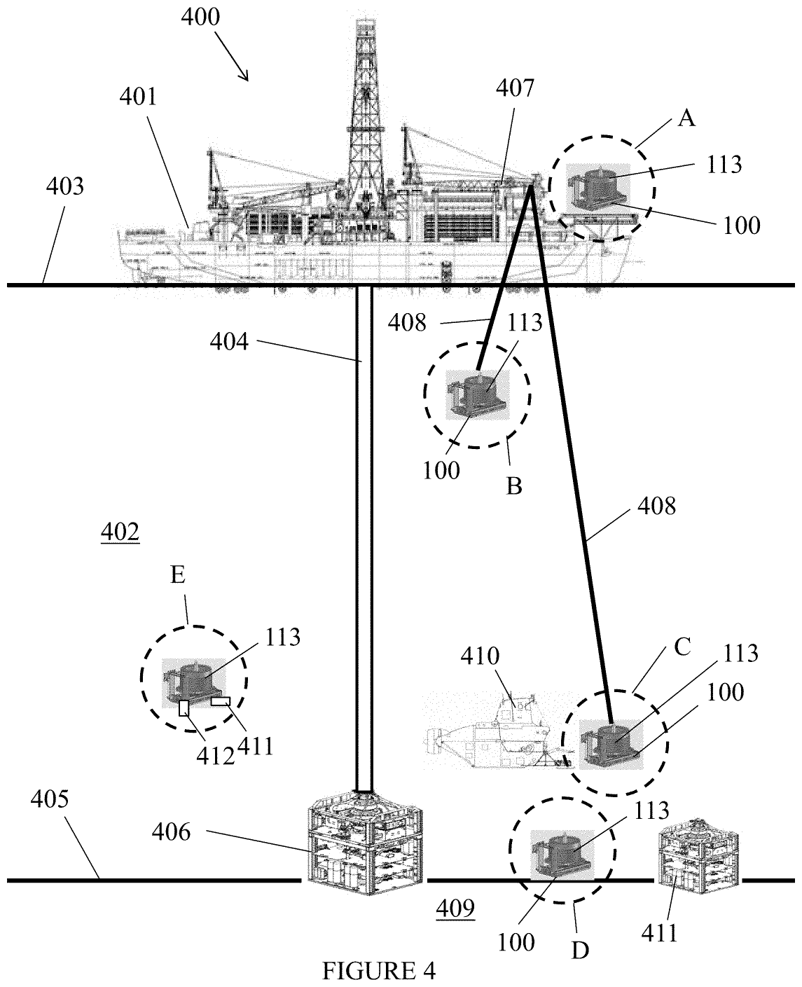

FIG. 4 illustrates the subsea cable transportation unit 100, as described in FIGS. 1-3, at various positions (dashed circle A, dashed circle B, dashed circle C, dashed circle D) in an offshore system 400 in accordance with embodiments disclosed herein. As shown in the dashed circle A, the subsea cable transportation unit 100 may be positioned on an offshore vessel 401 in a body of water 402. The offshore vessel 401 may be any offshore rig or platform, such as those used in oil and gas that may float at a surface 403 of the body of water 402. In some embodiments, a riser 404 may extend downwards from the offshore vessel 401 to a sea floor 405. Additionally, a subsea device 406 such as a wellhead may sit on the sea floor 405 and a lower end of the riser 404 connects to the subsea device 406. While the subsea cable transportation unit 100 is on the offshore vessel 401, the cable reel(s) 113 may be stored on the subsea cable transportation unit 100 to save space on the offshore vessel 401.

In one or more embodiments, in order to deploy the subsea umbilical transportation unit 100 into the body of water 402 at a subsea well site 409, a crane 407 on the offshore vessel 401 may be used to lift the subsea cable transportation unit 100 via the center post (119 in FIG. 1). In a non-limiting example, a line 408 of the crane 407 may be attached to the lift connection (120 in FIG. 1) of the center post (119 in FIG. 1). As shown in the dashed circle B, the crane 407 may lower the subsea cable transportation unit 100 below the surface 403 of the body of water 402 via the line 408. The crane 407 may further extend the line 408 to submerse the subsea cable transportation unit 100 to the subsea well site 409, as shown in the dashed circle C. Further, the subsea cable transportation unit 100 may be maintained at a distance above the sea floor 405. In a non-limiting example, the subsea cable transportation unit 100 may be 20 to 50 feet above the sea floor 405. In some embodiments, the offshore vessel 401 may use the line 408 to facilitate movement of the subsea cable transportation unit 100 within the body of water 402.

As shown in the dashed circle C of FIG. 4, in one or more embodiments, a remotely-operated-vehicle (ROV) 410 may operationally couple to the subsea cable transportation unit 100. The ROV 410 may be used to connect the first connection end (121a in FIG. 1) of the umbilical (114 in FIG. 1) to the subsea device 406, a second subsea device 411, the offshore vessel 401, or any combination thereof. Additionally, the ROV 410 may also be used to connect the second connection end (121b in FIG. 1) the subsea device 406, the second subsea device 411, or the offshore vessel 401 that the first connection end (121a in FIG. 1) is not connected to. Further, arms of the ROV 410 may grab the plurality of handles (139 in FIGS. 3A and 3B) of the front plate (128 in FIGS. 3A and 3B) to physically secure and align the ROV with the subsea cable transportation unit 100. In some embodiments, the ROV 410 may have a torque or hydraulics tool, such as a FLOT tool, that may be inserted into the drive connection (129 in FIGS. 2A-3B) of the subsea cable transportation unit 100. Through the drive connection (129 in FIGS. 2A-3B), the ROV 410 may provide torque or hydraulics to the drive unit (127 in FIGS. 2A and 2B). By providing torque or hydraulics with the ROV 410, the drive unit (127 in FIGS. 2A and 2B) may drive the storage structure (see 118 in FIGS. 1-2B). The storage structure (118 in FIGS. 1-2B) may rotate based on the power from the drive unit (127 in FIGS. 2A and 2B) to unspool or spool the cable reel 113 such that the cable (114 in FIG. 1) may reach various equipment (401, 406, 411) in the offshore system 400 without tension. Furthermore, the ROV 410 may have an additional tool to grab the handle (136 in FIGS. 2A-3A) or the hydraulic port (236 in FIG. 3B) to manually or hydraulically, via the hot stab (135 in FIG. 2A) or the hydraulic cylinder (223 in FIG. 3B), operate the level winder (122 in FIGS. 1-3B). By using the hot stab (135 in FIG. 2A) or the hydraulic cylinder (223 in FIG. 3B), the ROV 410 may vertically move the level winder (122 in FIGS. 1-3B) up and down the rod (123 in FIGS. 1-3) or the piston (223b in FIG. 3B) to level the first connection end (121a in FIG. 1) of the cable (114 in FIG. 1) based on height H of the cable (114 in FIG. 1) in the cable reel 113. By using the level winder (122 in FIGS. 1-3B), the cable (114 in FIG. 1) exits the subsea cable transportation unit 100 via the ramp (142 in FIG. 3) of the level winder (122 in FIGS. 1-3B) at a position based on the height H of the cable (114 in FIG. 1). Subsequently, tension that may be created in the cable (114 in FIG. 1) from exiting through the chute or ramp (142 in FIGS. 3A and 3B) may be eliminated as the chute or ramp (142 in FIGS. 3A and 3B) is at a movable height corresponding to the height H of the cable (114 in FIG. 1).

In one or more embodiments, with the ROV 410 attached to the subsea cable transportation unit 100, the ROV 410 may be used to direct the subsea cable transportation unit 100 through the body of water 402. In a non-limiting example, thrusters of the ROV 410 may be used to move and provide rotational stabilization for the subsea cable transportation unit 100. Additionally, the stabilizing fins (106a, 106b in FIG. 1) of the subsea cable transportation unit 100 may further stabilize the subsea cable transportation unit 100 as the stabilizing fins act as a hydrofoil to displace fluids (i.e., water) when the subsea cable transportation unit 100 is traveling through the body of water 402. It is further envisioned that the offshore vessel 401 may move in a direction corresponding to a movement direction of the subsea cable transportation unit 100. One skilled in the art will appreciate that the ROV 410 may be used to provide positioning information, water depth, heading, lights, and cameras for the subsea cable transportation unit 100. In some embodiments, the ROV 410 may be integrated into the subsea cable transportation unit 100. As shown in the dashed circle E of FIG. 4, a propulsion system 411 may be attached to the base platform (101 of FIGS. 1-3B) of the subsea cable transportation unit 100. The propulsion system 411 may be any motor or jet used in underwater environments. Additionally, a control system 412, such as a computer or processor, may be provided in the base platform (101 of FIGS. 1-3B) to operate all the components of the subsea cable transportation unit 100. It is further envisioned that the control system 412 may be integrated into propulsion system 411. By having the propulsion system 411 and control system 412, the subsea cable transportation unit 100 may be disconnected from the line 408 and may freely move through the body of water 402 based on commands sent from the offshore vessel 401.

As shown in the dashed circle D of FIG. 4, in one or more embodiments, the crane 407 may disengage the line 408 from the center post (119 in FIG. 1) to rest the subsea cable transportation unit 100 on the sea floor 405. For example, in a case of emergency such as bad weather conditions, the line 408 may be brought back the offshore vessel 401 while the subsea cable transportation unit 100 remains on the sea floor 405. In other embodiments, the line 408 may remain engaged with the subsea cable transportation unit 100 while the subsea cable transportation unit 100 remains on the sea floor 405. Additionally, once the weather conditions have improved, the crane 407 may redeploy the line 408 to be reattached to the center post (119 in FIG. 1) and begin to raise the subsea cable transportation unit 100 off the sea floor 405. It is further envisioned that while the subsea cable transportation unit 100 is resting on the sea floor 405, the cable reel 113 may be unloaded and installed on the sea floor 405. In a non-limiting example, hydraulics in the base platform (101 of FIGS. 1-3B) of the subsea cable transportation unit 100 may lift the cable reel 113 off the subsea cable transportation unit 100 and place the cable reel 113 on the sea floor 405. Additionally, the crane 407 may use an arm or hook at the end of the line 408 to grab and lift the cable reel 113 off the subsea cable transportation unit 100 and place the cable reel 113 on the sea floor 405. Further, the ROV 410 may assist the subsea cable transportation unit 100 and the crane 407 to lift the cable reel 113 off the subsea cable transportation unit 100 and place the cable reel 113 on the sea floor 405.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A subsea cable transportation unit comprising:
a base platform;
a drive unit provided within the base platform;
a storage structure provided on the base platform and operationally coupled to the drive unit, wherein the storage structure is configured to receive a drum;
at least one drive connection provided on a surface of the base platform, wherein the at least one drive connection is operationally coupled to the drive unit and configured to provide torque or hydraulics to operate the drive unit, wherein the storage structure is configured to rotate based on the torque or hydraulics and unspool or spool a cable wrapped around the drum; and
a stabilizing fin extending outwardly from the base platform, the stabilizing fin comprising a hydrofoil.

2. The subsea umbilical transportation unit of claim 1, the drive unit comprising:
a shaft having a first end attached to the at least one drive connection;
a motor attached to a second end of the shaft; and
a gear operationally coupled to the motor.

3. The subsea umbilical transportation unit of claim 2, wherein a peripheral edge of the storage structure comprises teeth and the teeth are engaged with corresponding teeth of the gear.

4. The subsea umbilical transportation unit of claim 1, further comprising a level winder movably coupled to a rod on the base platform, wherein the level winder is configured to move up and down the rod based on a height of the cable wrapped around the drum.

5. The subsea umbilical transportation unit of claim 1, further comprising a center post extending outwardly from the base platform, the center post comprising a lift connection.

6. A subsea cable installation and recovery system comprising:
a subsea cable transportation unit, the subsea cable transportation unit comprising:
a base platform, wherein a drive unit is provided within the base platform;
a storage structure provided on the base platform and operationally coupled to the drive unit;
a stabilizing fin extending outwardly from the base platform,
wherein the stabilizing fin comprises a hydrofoil configured to displace fluids and stabilize the subsea cable transportation unit submerged in the body of water; and
a cable reel installed on the storage structure, wherein the drive unit is configured to rotate the storage structure to turn the cable reel, wherein the cable reel comprises a spool of cable wrapped around a drum.

7. The subsea cable installation and recovery system of claim 6, further comprising an offshore vessel at a surface of a body of water, the offshore vessel comprising a crane and a line coupled to the crane, the line removably attached to the subsea umbilical transportation unit.

8. The subsea cable installation and recovery system of claim 6, wherein the storage structure comprises a locking device to lock the drum on the storage structure.

9. The subsea cable installation and recovery system of claim 6, further comprising a remotely-operated-vehicle (ROV) operationally coupled to the subsea cable transportation unit.

10. The subsea cable installation and recovery system of claim 9, wherein the ROV is removably coupled to at least one drive connection of the subsea cable transportation unit and is configured to transmit torque or hydraulics to the drive unit through the at least one drive connection.

11. The subsea cable installation and recovery system of claim 9, wherein the ROV comprises thrusters to move the subsea cable transportation unit within the body of water.

12. The subsea cable installation and recovery system of claim 6, further comprising a level winder movably coupled to a rod or hydraulic cylinder on the base platform, wherein the level winder is configured to move up and down the rod or up and down based in response to the hydraulic cylinder based on a height of the spool of cable wrapped around the drum.

13. The subsea cable installation and recovery system of claim 12, further comprising a remotely-operated-vehicle (ROV) operationally coupled to a hot stab of the level winder to move the level winder up and down as the height of the spool of cable changes from unspooling or spooling.

14. A method comprising:
deploying a subsea cable transportation unit in a body of water at an offshore site;
directing the subsea cable transportation unit through the body of water; and
torqueing a drive unit provided within a base platform of the subsea cable transportation unit to drive a storage structure installed on the base platform;
rotating the rotatable table with power from the drive unit, thereby unspooling or spooling a spool of cable installed on the storage structure; and
stabilizing the subsea cable transportation unit in the body of water with a stabilizing fin positioned outwardly from the base platform.

15. The method of claim 14, wherein the deploying of the subsea cable transportation unit comprises:
lifting the subsea cable transportation unit off an offshore vessel with a crane attached to a post extending outwardly from the base platform;
lowering the subsea cable transportation unit into the body of water with the crane; and
submersing the subsea cable transportation unit in the body of water and moving the subsea cable transportation unit to a subsea site.

16. The method of claim 15, further comprising maintaining the subsea cable transportation unit at a distance of 20 to 50 feet above a sea floor.

17. The method of claim 16, further comprising lowering the subsea cable transportation unit to the sea floor.

18. The method of claim 14, wherein the torqueing the drive unit comprises operationally coupling a remotely-operated-vehicle (ROV) to a torque connection of the subsea cable transportation unit and providing a drive torque to the drive unit.

19. The method of claim 18, further comprising operationally coupling the ROV to a hot stab of a level winder movably coupled to the base platform, and mechanically or hydraulically moving the level winder up and down based on a height of the spool of cable.

20. The method of claim 19, further comprising sliding the spool of cable down a chute or ramp of the level winder.
